(19) United States
(12) Patent Application Publication
(10) Pub. No.: US 2012/0065757 A1
(43) Pub. Date: Mar. 15, 2012

(54) HONEYCOMB PACKING SYSTEM, METHOD AND APPARATUS

(76) Inventors: Alan Tepe, (US); Dennis Fernandez, (US)

(21) Appl. No.: 13/253,923

(22) Filed: Oct. 5, 2011

Related U.S. Application Data
(63) Continuation of application No. PCT/US2010/032449, filed on Apr. 26, 2010.
(60) Provisional application No. 61/214,481, filed on Apr. 24, 2009.

(51) Int. Cl. G06F 17/50

(52) U.S. Cl. 700/98

(57) ABSTRACT

A system and method of forming a honeycomb structure includes selecting a desired honeycomb structure shape, forming a plurality of two dimensional sheets into desired two dimensional shapes corresponding to the selected honeycomb structure shape, stacking the plurality of two dimensional sheets, connecting the plurality of two dimensionally shaped sheets along corresponding connection lines and spreading the plurality of sheets apart.

This application is a continuation of and claims priority from PCT/US2010/032449, filed Apr. 26, 2010 and entitled “Honeycomb Packing System, Method and Apparatus,” which claims priority from U.S. Provisional Patent Application No. 61/214,481 filed on Apr. 24, 2009 and entitled “Honeycomb Structure of Desired Overall Shape Formed with Sheets,” both of which are incorporated herein by reference in their entirety and for all purposes.

### BACKGROUND

The present invention relates generally to honeycomb type packing systems, and more particularly, to a system, method and apparatus for making honeycomb structures with a desired overall shape using multiple, precut two dimensional sheets of material.

Typical three dimensional honeycomb packing or other support structures are formed by first forming a three dimensional shape, e.g., a six-sided rectangular box, that is completely filled with corrugated material (e.g., paper, cardboard). Next, the desired three-dimensional void is cut out of the corrugated material.

This typical approach to forming a three dimensional honeycomb packing or other support structure is limited in the shapes that can be formed and is excessively wasteful of material and excessively costly in manufacturing processes.

In view of the foregoing, there is a need for a more material efficient, simpler system, method and apparatus for forming a corrugated support structure.

### SUMMARY

Broadly speaking, the present invention fills these needs by providing a system, method and apparatus for making honeycomb structures with a desired overall shape using multiple, precut two dimensional sheets of material. It should be appreciated that the present invention can be implemented in numerous ways, including as a process, an apparatus, a system, computer readable media, or a device. Several inventive embodiments of the present invention are described below.

One embodiment provides a system and method of forming a honeycomb structure includes selecting a desired honeycomb structure shape, forming a plurality of two dimensional sheets into desired two dimensional shapes corresponding to the selected honeycomb structure shape, stacking the plurality of two dimensional sheets, connecting the plurality of two dimensionally shaped sheets along corresponding connection lines and spreading the plurality of sheets apart.

Selecting the desired honeycomb structure shape can include selecting a honeycomb structure density, including selecting a number of two-dimensional sheets in the plurality of two-dimensional sheets and selecting a spacing interval between the corresponding connection lines on each of the plurality of two-dimensional sheets. Selecting the desired honeycomb structure shape can include selecting a honeycomb structure orientation.

Forming the plurality of two dimensional sheets into desired two dimensional shapes can include creating a three-dimensional honeycomb model including a first set of coordinates, selecting a sheet in the three-dimensional honeycomb model, identifying a second set of coordinates in the selected sheet, the second set of coordinates being a subset of the first set of coordinates. Forming the plurality of two dimensional sheets into desired two dimensional shapes can also include translating the second set of coordinates to a third set of coordinates, the third set of coordinates being relative to a selected point in the selected sheet, creating a space model of a three-dimensional space in the honeycomb structure, identifying portion of the third set of coordinates are included in the space model, and identifying cutouts in the selected sheet.

The three-dimensional space model can be a space formed in the honeycomb structure. The three-dimensional space model can include at least one of a curve, a complex curve or a straight edge.

A stiffening sheet can be attached to the honeycomb structure. An expandable outer casing can be attached to a top sheet and a bottom sheet of the honeycomb structure. The expandable outer casing can include at least one side, the at least one side having a fold. Spreading the plurality of sheets apart can include moving the fold in the at least one side of the expandable outer casing toward the honeycomb structure.

The at least one side of the expandable outer casing can be secured such that the honeycomb structure is held in an extended orientation. Securing the at least one side of the expandable outer casing can include placing a sleeve over the honeycomb structure.

Another embodiment provides a system for forming a honeycomb structure. The system includes a forming system, an adhesive application system and a shaping system. The forming system for forming a plurality of substantially two dimensional sheets into desired two dimensional shapes corresponding to a selected honeycomb structure shape. The adhesive application system for connecting the plurality of two dimensionally shaped sheets along corresponding connection lines. The shaping system for spreading the plurality of sheets apart.

The system can also include a controller. The system can also include logic for creating a three-dimensional honeycomb model including a first set of coordinates, logic for selecting a sheet in the three-dimensional honeycomb model, logic for identifying a second set of coordinates in the selected sheet, the second set of coordinates being a subset of the first set of coordinates, logic for translating the second set of coordinates to a third set of coordinates, the third set of coordinates being relative to a selected point in the selected sheet, logic for creating a space model of a three-dimensional space in the honeycomb structure, logic for identifying portion of the third set of coordinates are included in the space model and logic for identifying cutouts in the selected sheet.

The system can also include logic for selecting a desired honeycomb structure shape including logic for selecting a honeycomb structure density, including logic for selecting a number of two-dimensional sheets in the plurality of two-dimensional sheets and logic for selecting a spacing interval between the corresponding connection lines on each of the plurality of two-dimensional sheets.

Yet another embodiment provides a packing system. The packing system includes a forming system for forming a plurality of substantially two-dimensional sheets into desired two-dimensional shapes corresponding to a selected honeycomb structure shape corresponding to an object to be supported in the packing system, a adhesive application system for connecting the plurality of two-dimensionally shaped sheets along corresponding connection lines, and a shaping system for spreading the plurality of sheets apart.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIGS. 1A-F show several variations of honeycomb structures, in accordance with one or more embodiments of the present invention.

FIG. 2A is a progression of the assembly of the honeycomb structure, in accordance with one or more embodiments of the present invention.

FIG. 2B is a progression of the assembly of a honeycomb structure using multiple pre-formed waving sheets, in accordance with one or more embodiments of the present invention.

FIG. 2C shows a honeycomb structure with an added stiffening sheet, in accordance with one or more embodiments of the present invention.

FIG. 3 is a progression of the assembly of a honeycomb structure with a three dimensional space formed therein, in accordance with one or more embodiments of the present invention.

FIGS. 4A-4D is a progression of the assembly of a honeycomb structure with a three dimensional space formed therein, in accordance with one or more embodiments of the present invention.

FIG. 5A is a flowchart diagram that illustrates the method operations performed in forming the honeycomb structure, in accordance with one or more embodiments of the present invention.

FIG. 5B is a flowchart diagram that illustrates the method operations performed in determining a corresponding shape for each one of the two-dimensional sheets in the honeycomb structure, in accordance with one or more embodiments of the present invention.

FIG. 6 is a honeycomb assembly, in accordance with one or more embodiments of the present invention.

FIG. 7 is a sleeve, in accordance with one or more embodiments of the present invention.

FIG. 8 shows a packing system, in accordance with one or more embodiments of the present invention.

FIG. 9 shows a packing system with multiple honeycomb assemblies, in accordance with one or more embodiments of the present invention.

FIG. 10 is a system for forming honeycomb structures, in accordance with one or more embodiments of the present invention.

### DETAILED DESCRIPTION

Several exemplary embodiments for system, method and apparatus for making honeycomb structures with a desired overall shape using multiple, precut two dimensional sheets of material, will now be described. It will be apparent to those skilled in the art that the present invention may be practiced without some or all of the specific details set forth herein.

system, method and apparatus for making honeycomb structures with a desired overall shape using multiple, precut two dimensional sheets of material, connecting the two dimensional sheets of material and spreading the two dimensional sheets of material apart to form a desired three dimensional honeycomb support structure

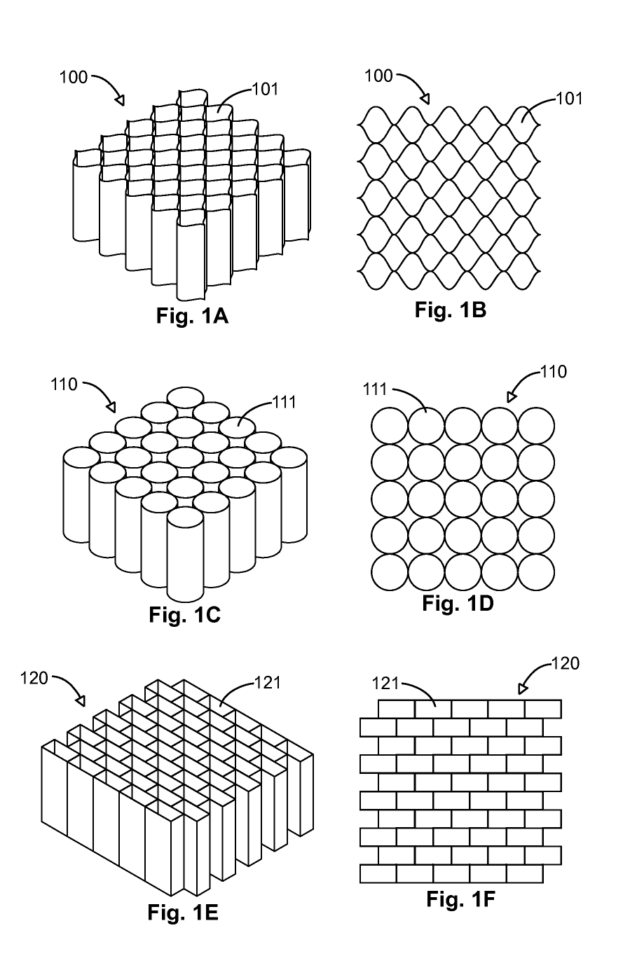

FIGS. 1A-F show several variations of honeycomb structures 100, 110, 120, in accordance with one or more embodiments of the present invention. The honeycomb structures 100, 110, 120 include multiple, connected, open ended cells 101, 111, 121. Each of the cells 101, 111, 121 may be of any desired shape and size (four-sided 101, hexagonal, circular 111, oval, rectangular 121 . . . ). The honeycomb structures 100, 110, 120 can be formed of any desired material (paper, metal, plastic, composites, wood and any similar suitable sheet type products and combinations thereof . . . ).

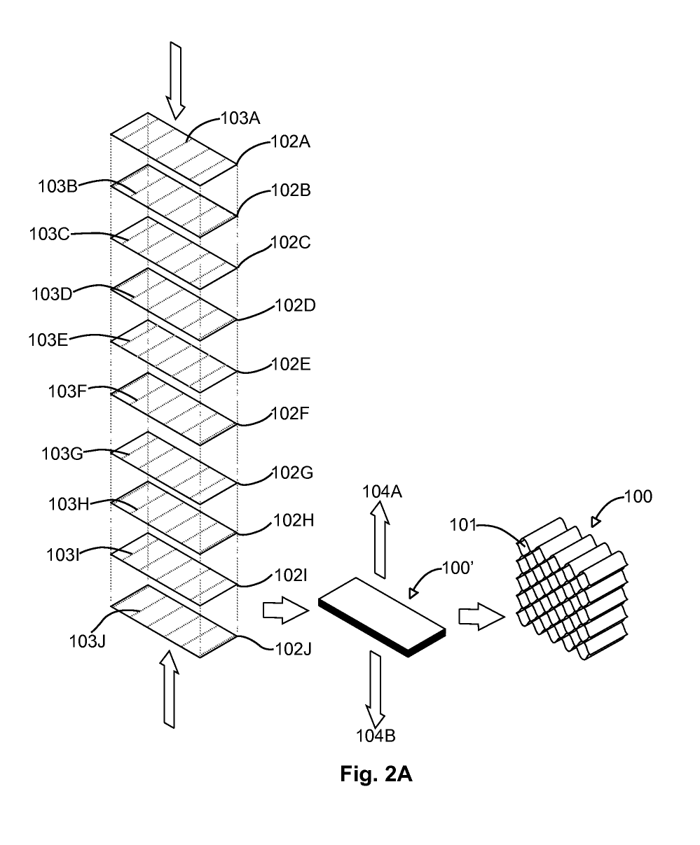

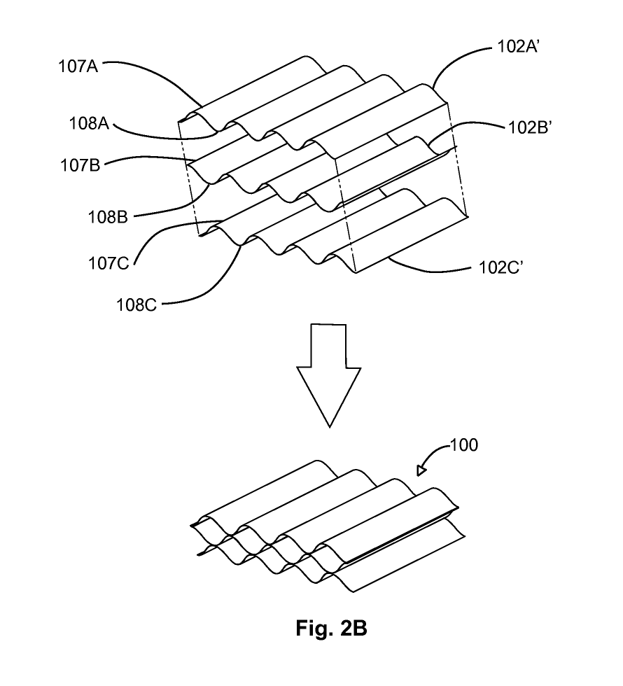

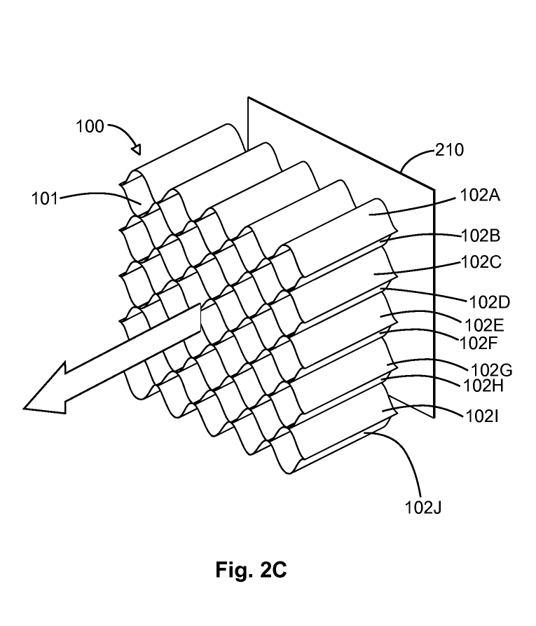

FIG. 2A is a progression of the assembly of the honeycomb structure 100, in accordance with one or more embodiments of the present invention. The honeycomb structure 100 is formed by stacking multiple flat sheets 102A-102J of the desired material on top of each other. Each sheet 102A-102J in the stack is connected to the sheet on top of it along spaced and parallel connection lines 103A-J.

The connection lines 103A-J on one side of each sheet 102A-102J are aligned between the connection lines 103A-J on the other side of the same sheet. By way of example, the connection lines 103D on sheet 102D are substantially centered between the connection lines 103E on sheet 102E and the connection lines 103C on sheet 102C.

The stack 100′ of the connected sheets 102A-102J is shown laying flat. The flat stack of connected sheets 100′ is then spread in direction 104A and 104B to expand the stack 100′ into honeycomb structure 100. Note that the distance between the parallel connection lines 103A-J on each corresponding sheet 102A-J determines a size (e.g., width and/or diameter) of each cell 101 in the honeycomb structure.

The sheets 102A-102J can be formed from the same or different materials. By way of example, the sheet 102A can be a sheet of paper having a first thickness and sheet 102B can be form from paper having a second thickness. The second thickness of sheet 102B being greater than the first thickness of sheet 102A. Similarly, sheet 102A can be formed from a sheet of paper and sheet 102B can be formed from a sheet of plastic or aluminum or a composite material or other suitable materials or combinations thereof.

FIG. 2B is a progression of the assembly of a honeycomb structure 100 using multiple pre-formed waving sheets 102A′-102C′, in accordance with one or more embodiments of the present invention. The honeycomb structure 100 is formed by stacking multiple sheets 102A′-C′. Each of the multiple sheets 102A′-C′ have a substantially evenly repeating wave shape. The substantially evenly repeating wave shape has corresponding peaks 107A-C and valleys 108A-C.

The sheets 102A′-C′ are stacked such that the peaks of a bottom sheet are aligned with the valleys of the next adjacent sheet above. By way of example, the peaks 107B of sheet 102B′ are aligned with the valleys 108A of sheet 102A′. Similarly, the peaks 107C of sheet 102C′ are aligned with the valleys 108B of sheet 102B′. The sheets 102A′-C′ are connected peak 107A-C to valley 108A-C of the next adjacent sheet above to form the honeycomb structure 100.

Honeycomb structures have a high strength to weight ratio. Honeycomb structures can be very stiff and resilient to impact, even if the component materials (e.g., materials forming the sheets 102A-102J) are not very stiff or strong. The stiffness of honeycomb structure varies with orientation of the structure. Honeycomb structure is stiffest in the direction parallel to the walls of each cell 101.

FIG. 2C shows a honeycomb structure 100 with an added stiffening sheet 210, in accordance with one or more embodiments of the present invention. The honeycomb structure 100 is stiffened by attaching supporting sheet of material 210 to one or both open ends of the cells 101 of the honeycomb structure. The supporting sheet 210 stiffens the honeycomb structure 100 in an orientation other than the direction parallel to the walls of each cell 101.

Specifically, the supporting sheet 210 stiffens the honeycomb structure 100 in an orientation parallel to the supporting sheet 210. The supporting sheet 210 attached to the open ends of the honeycomb cells 101 in the honeycomb structure 100 makes the structure stiffer in directions normal to the walls of each cell.

The supporting sheet 210 can be connected to the one or both open ends of the cells 101 using the same or different connecting methods as used to connect the sheets 102A-C together. The supporting sheet 210 can be the same or different material than the sheets 102A-C. By way of example, the supporting sheet 210 can be a heavier (i.e., thicker) form of the same material as the sheets 102A-C. Alternatively, the supporting sheet 210 can be formed from a plastic, a metal, a composite or other suitable materials or combinations thereof and the sheets 102A-C can be a paper or wood product.

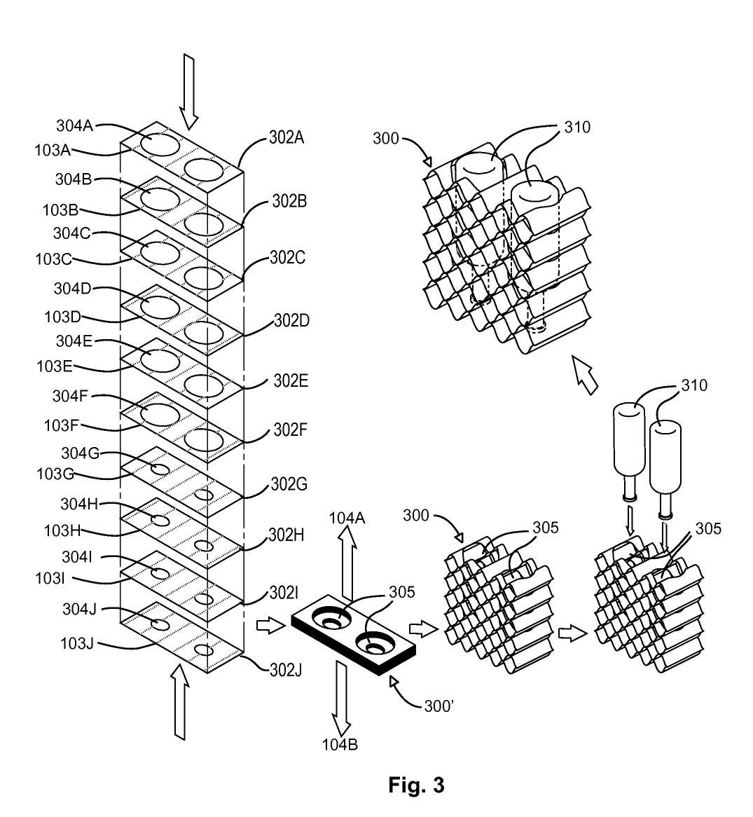

FIG. 3 is a progression of the assembly of a honeycomb structure 300 with a three dimensional space 305 formed therein, in accordance with one or more embodiments of the present invention. The two dimensional shape and/or dimensions of each of the individual sheets 302A-J that form the honeycomb structure 300 can be adjusted to create honeycomb structures with any desired overall shape. The overall shapes of the honeycomb structure 300 can be complex and non-rectangular.

Each of the sheets 302A-J have corresponding cut outs 304A-J. The cut outs 304A-J correspond to a desired shape, in this instance a bottle shape. When expanded into three dimensional form, the resulting three dimensional space 305 in the honeycomb structure 300 is formed. It should be understood that the specific shape of cut outs 304A-J correspond to the angle(s) at which the corresponding sheet will meet the desired three dimensional space 305. As a result, a cut out shape for a round shape may have an oval or other shape when the sheet 302A-J is in two dimensional form.

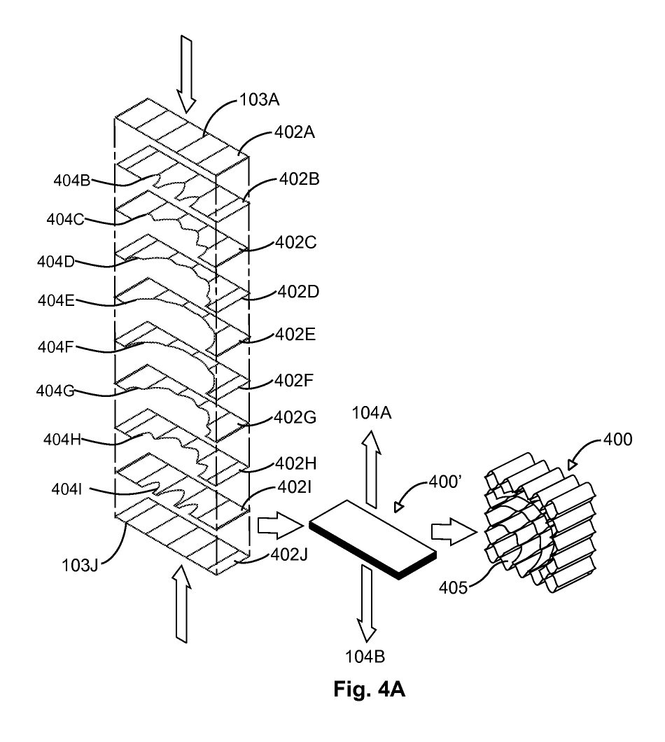

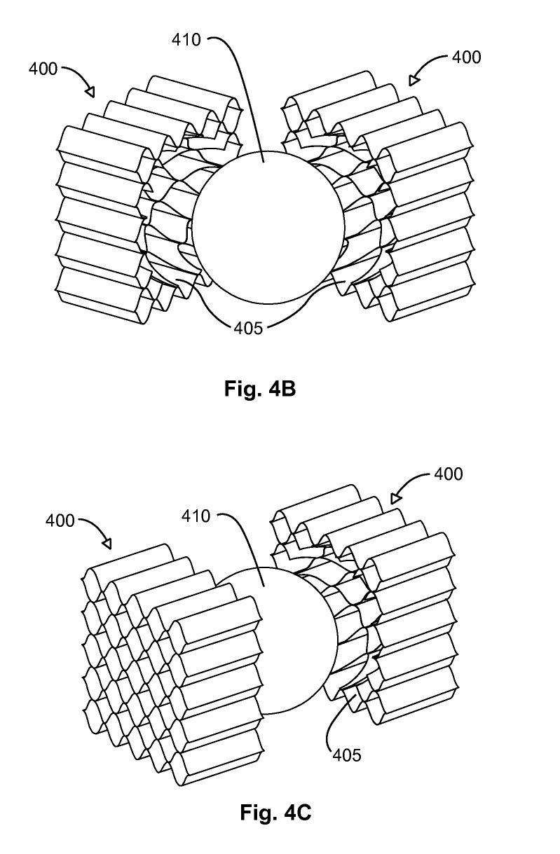

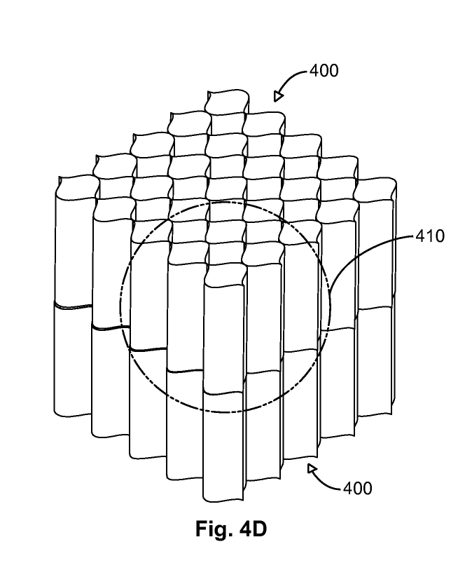

FIGS. 4A-4D is a progression of the assembly of a honeycomb structure 400 with a three dimensional space 405 formed therein, in accordance with one or more embodiments of the present invention. Specifically, the three dimensional space 405 is a half sphere. The sheets 402B-I have corresponding cutouts 404B-404I. A corresponding sphere 410 is shown in FIGS. 4B-D with two of the honeycomb structures 400.

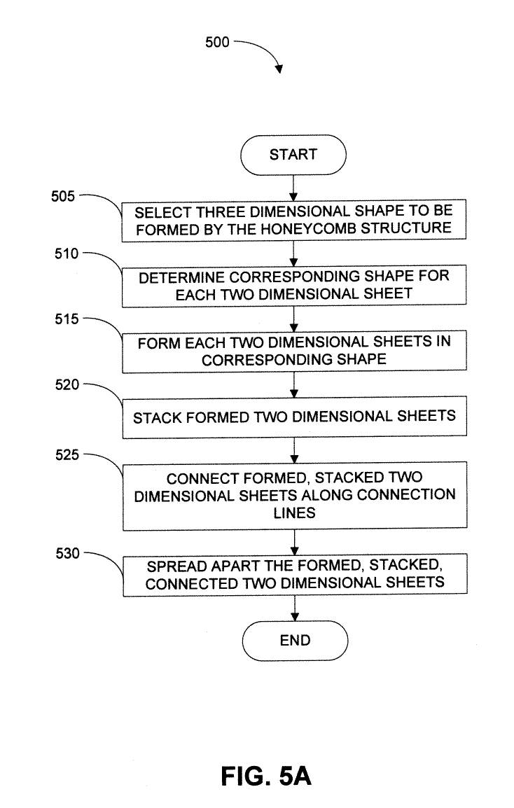

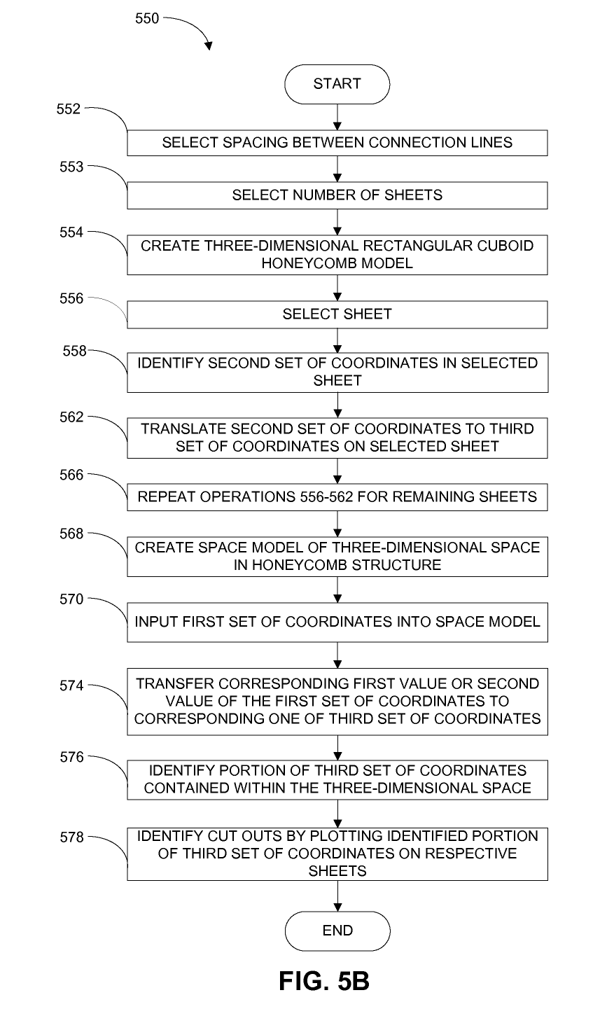

FIG. 5A is a flowchart diagram that illustrates the method operations 500 performed in forming the honeycomb structure 200, 300, 400, in accordance with one or more embodiments of the present invention. The operations illustrated herein are by way of example, as it should be understood that some operations may have sub-operations and in other instances, certain operations described herein may not be included in the illustrated operations. It should also be understood that a portion of or all of the operations illustrated herein can be implemented as logical operations (e.g., implemented in software or hardware or combinations thereof) that are capable of being executed by a suitable system. With this in mind, the method and operations 500 will now be described. Creating a selected three dimensional shape or space 305, 405 inside the honeycomb structure 300, 400, includes determining the specific shapes and sizes of each of the sheets 302A-J, 402A-J that make up the honeycomb structure 300, 400.

In an operation 505, select a three dimensional shape or space 305, 405 to be formed inside the honeycomb structure 300, 400. In an operation 510, determine a corresponding shape for each one of the two-dimensional sheets 302A-J, 402A-J in the honeycomb structure 300, 400.

In an operation 515, form each of the two-dimensional sheets 302A-J, 402A-J in the honeycomb structure 300, 400 in the corresponding shape. By way of example, forming each of the two-dimensional sheets 302A-J, 402A-J into the corresponding shape can include forming cut outs 304A-J, 404B-I as shown in FIGS. 3 and 4A.

In an operation 520, the formed two-dimensional sheets 302A-J, 402A-J are stacked together. In an operation 525, each of the formed two-dimensional sheets 302A-J, 402A-J are connected to the adjacent sheet on top of it along connection lines 303A-J, 403A-J.

In an operation 530, the stack of formed two-dimensional sheets 302A-J, 402A-J are spreading apart in directions 104A, 104B to form a honeycomb structure 300, 400 having the selected a three-dimensional space 305, 405.

FIG. 5B is a flowchart diagram that illustrates the method operations 550 performed in determining a corresponding shape for each one of the two-dimensional sheets 302A-J, 402A-J in the honeycomb structure 300, 400, in accordance with one or more embodiments of the present invention. The operations illustrated herein are by way of example, as it should be understood that some operations may have sub-operations and in other instances, certain operations described herein may not be included in the illustrated operations. It should also be understood that a portion of or all of the operations illustrated herein can be implemented as logical operations (e.g., implemented in software or hardware or combinations thereof) that are capable of being executed by a suitable system. With this in mind, the method and operations 550 will now be described.

In an operation 552, a spacing between the connection lines 103A-J for the honeycomb structure 300, 400 is selected. In an operation 553, a number of the sheets 302A-J, 402A-J for the honeycomb structure 300, 400 is selected. The spacing between the connection lines 103A-J and the number of the sheets 302A-J, 402A-J determines a desired size and density of the honeycomb cells 101.

In an operation 554, a three-dimensional rectangular cuboid honeycomb model of the expanded honeycomb structure 300, 400 is created. The honeycomb model is large enough to completely contain the expanded honeycomb structure 300, 400. The honeycomb model includes a first set of coordinates in three-dimensions (e.g., X, Y and Z planes). The first set of coordinates represents the surfaces of each sheet 302A-J, 402A-J in the expanded honeycomb structure 300, 400. The first set of coordinates is defined in reference to a defined origin at a selected point within or on the expanded honeycomb structure 300, 400. The sheets 302A-J, 402A-J follow a substantially sinusoidal pattern when viewed perpendicular to the honeycomb cells 101. As described above, each sheet 302A-J, 402A-J alternatively contacts the adjacent two sheets along the respective connection lines 103A-J.

In an operation 556, a first one of the sheets 302A-J, 402A-J is selected. In an operation 558, the selected sheet 302A-J, 402A-J is analyzed to identify a second set of coordinates. The second set of coordinates is a subset of the first set of coordinates that is included in the selected sheet.

In an operation 562, translate each one of the second set of coordinates to a third set of coordinates. Each of the third set of coordinates is a corresponding two-dimensional coordinate on the selected sheet 302A-J, 402A-J. The corresponding two-dimensional coordinate on the selected sheet 302A-J, 402A-J is determined relative to a selected point on the selected sheet (e.g., a selected corner or center or centerpoint on a selected edge of the selected sheet).

In an operation 566, operations 556-562 are repeated for the remaining sheets 302A-J, 402A-J. This translates a location of each of the second set of coordinates into a corresponding one of the third set of coordinates as a two-dimensional coordinate on the respective one of the sheets 302A-J, 402A-J.

In an operation 568, a three-dimensional space model of the three-dimensional space 305, 405 is created. The space model is a mathematical function of a three-dimensional coordinate. The three-dimensional space model can include one or more of a curve, a complex curve or a straight edge. By way of example, the three-dimensional space model can include simple geometric shapes (e.g., pyramidal shapes, cuboid, rectangular, cylindrical, spherical or complex shapes combining one or more geometrical shapes and complex curves. The mathematical function outputs a first value if the input coordinate is contained within the three-dimensional space 305, 405 and a second value if the input coordinate is not contained within (i.e., is external to) the three-dimensional space 305, 405.

In an operation 570, each of the first set of coordinates are input into the space model to identify a corresponding first value or second value of the mathematical function. The corresponding first value or second value is recorded for each of the first set of coordinates. In an operation 574, transfer the corresponding first value or second value of each of the first set of coordinates to their corresponding one of the third set of coordinates.

In an operation 576, identify a portion of the third set of coordinates that have the first value (e.g., are contained within the three-dimensional space 305, 405). In an operation 578, identify the cut outs 304A-J, 404B-I by plotting the identified portion of the third set of coordinates on the respective sheets 302A-J, 402A-J.

The systems, method and apparatus presented herein are more efficient in material usage and can provide more precisely formed three-dimensional space 305, 405 than typical processes. An orientation of the cells 101 within a honeycomb structure 300, 400 can be varied. By way of example, a bottle shape 305 can be created with the open ends of honeycomb cells 101 aligned toward the circular end of the bottle shape 305 (not shown in FIG. 3). Alternatively, the bottle shape 305 can be created with the open ends of honeycomb cells 101 aligned substantially perpendicular to the side of the bottle shape 305 as shown in FIG. 3.

Alternatively, the bottle shape 305 can be created with the open ends of honeycomb cells 101 aligned at a selected angle between 0 and 90 degrees to the side of the bottle shape 305. Because the stiffness of honeycomb structure 200, 300, 400 varies with the orientation of the cells 101, it is possible to create complex overall shapes of honeycomb structure with the maximum stiffness in one or more desired directions.

The stiffness of honeycomb structures 200, 300, 400 increases as the size (e.g., width and/or diameter) of individual cells 101 in the structure decreases. The sizes of cells in honeycomb structures 200, 300, 400 correlates to the distance between the connection lines 103A-J, on each sheet 102A-J, 302A-J and 402A-J.

Due to the high strength to weight ratio of honeycomb structures 200, 300, 400, and the fact that the stiffness of the structure can be selected for specific applications, honeycomb structures of complex shape can have a large variety of uses. By way of example: honeycomb structures with a complex shape, precise packaging to protect complex shaped objects from impacts; complex structures for packaging works of art (e.g., statuary), inexpensive visual and three-dimensional prototyping, structural support for vehicles or buildings, structures to fill voids, and other structures.

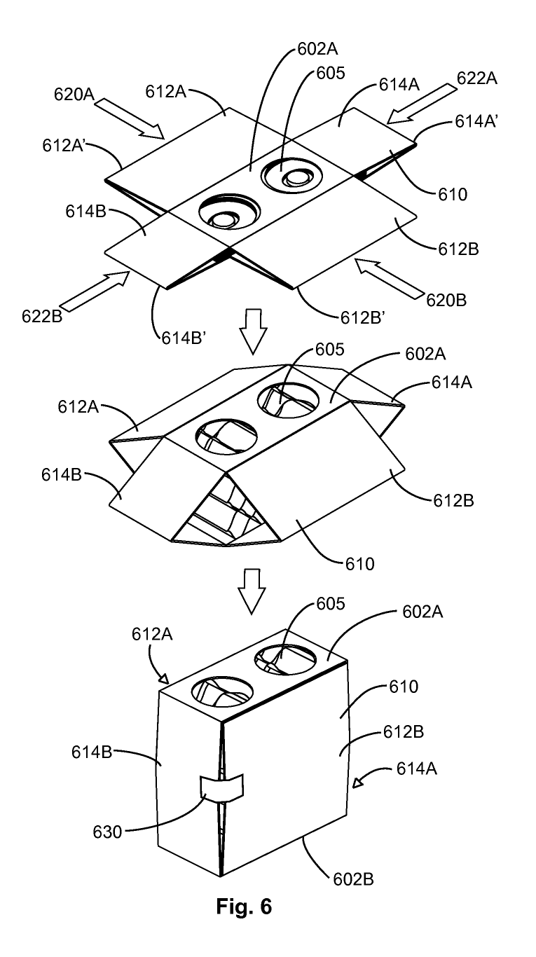

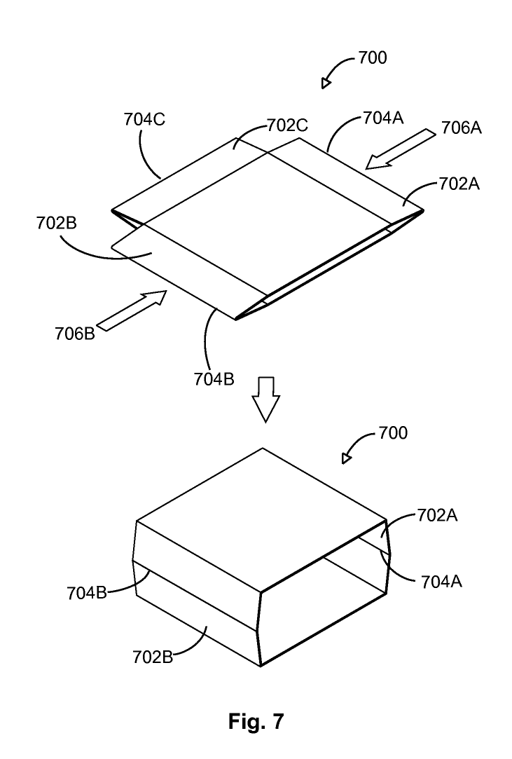

FIG. 6 is a honeycomb assembly 600, in accordance with one or more embodiments of the present invention. The honeycomb assembly 600 includes the honeycomb structure 300 described above and an expandable outer casing 610. The honeycomb structure 300 includes a three dimensional space 605 formed therein. The expandable outer casing 610 provides additional support and stiffening similar to the stiffening sheet 210.

The expandable outer casing 610 includes a first end 602A and a second end 602B opposite the first end. The expandable outer casing 610 includes at least one side (e.g., a first side 612A). A second side 612B, opposite the first side, can also be included as shown. The expandable outer casing 610 can optionally include an optional third side 614A and an optional fourth side 614B opposite the third side. The sides 612A, 612B and optional sides 614A, 614B include corresponding folds 612A′, 612B′, 614A′, 614B′.

A first end 602A of expandable outer casing 610 can be connected to the first sheet 302A of the honeycomb structure 300. The first end 602A of expandable outer casing 610 can be the first sheet 302A of the honeycomb structure 300.

A second end 602B of expandable outer casing 610 can be connected to the first sheet 302J of the honeycomb structure 300. The second end 602B of expandable outer casing 610 can be the bottom sheet 302J of the honeycomb structure 300.

Moving the corresponding folds 612A′, 612B′, 614A′, 614B′ in respective directions 620A, 620B, 622A, 622B toward the honeycomb structure 300 causes the first end 602A and the second end 602B to move apart and expand the honeycomb structure 300. An optional fastener 630 can be secured to one or more of the sides 612A, 612B, 614A, 614B to hold the honeycomb structure 300 in the extended orientation. The optional fastener 630 can be and adhesive tape or flap or other suitable fastener. The optional fastener 630 can wrap fully around the expandable outer casing 610 to hold the honeycomb structure 300 in the extended orientation.

FIG. 7 is a sleeve 700, in accordance with one or more embodiments of the present invention. The sleeve 700 is a six-sided box with one open side. The sleeve 700 is collapsible as the sides 702A-C have corresponding folds 704A-C. Pressing the side 702A in direction 706A and pressing the side 702B in direction 706B causes the sleeve to expand.

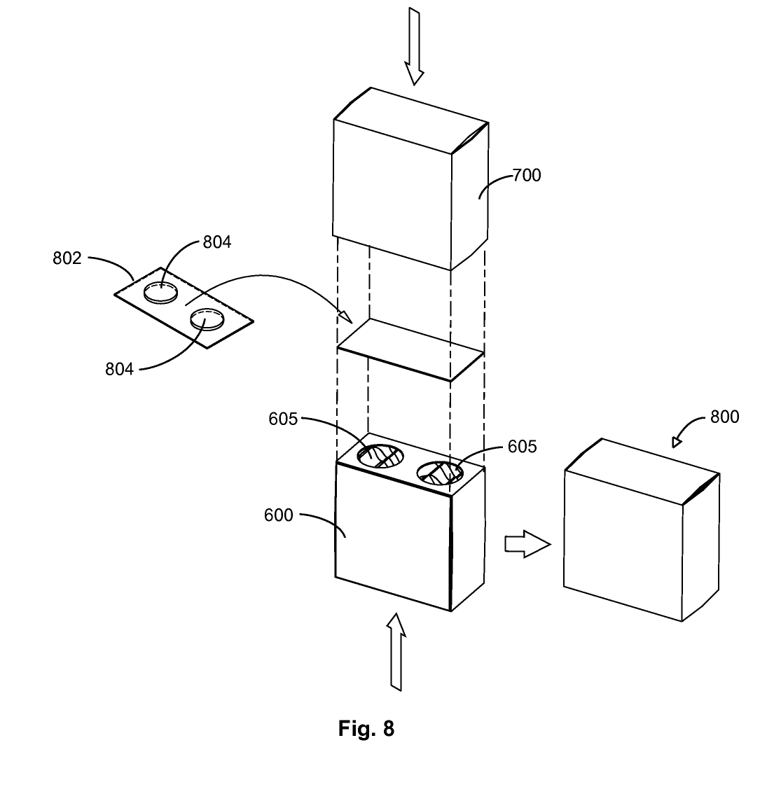

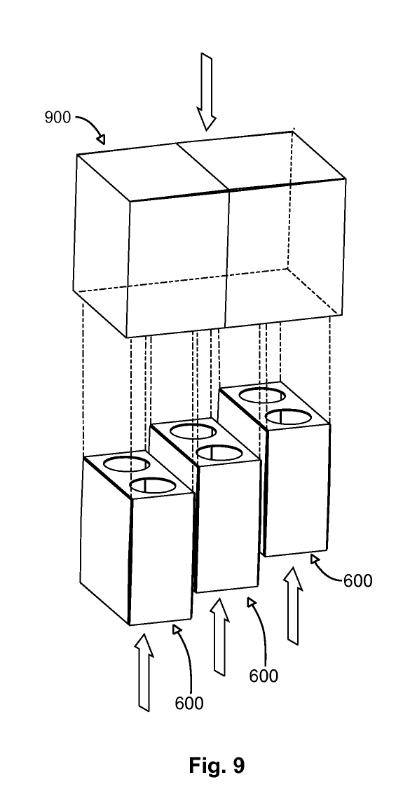

FIG. 8 shows a packing system 800, in accordance with one or more embodiments of the present invention. The packing system 800 includes the honeycomb assembly 600 and the sleeve 700. The sleeve 700 holds the expandable outer casing 610 of the honeycomb assembly 600 in the expanded orientation similar to the optional fastener 630.

The packing system 800 can also include one or more inserts 802. The inserts 802 can include additional cushioning 804 for the cargo to be packed in the three-dimensional space 605. The inserts 802 can be shaped to correspond to the openings of the three-dimensional space 605 so that the inserts 802 can interlock with the openings of the three-dimensional space 605.

FIG. 9 shows a packing system 900 with multiple honeycomb assemblies 600, in accordance with one or more embodiments of the present invention. The packing system 900 includes the honeycomb assemblies 600 and a larger sleeve 900. The larger sleeve 900 is capable of holding multiple honeycomb assemblies 600 in the expanded orientation similar to the packing system 800.

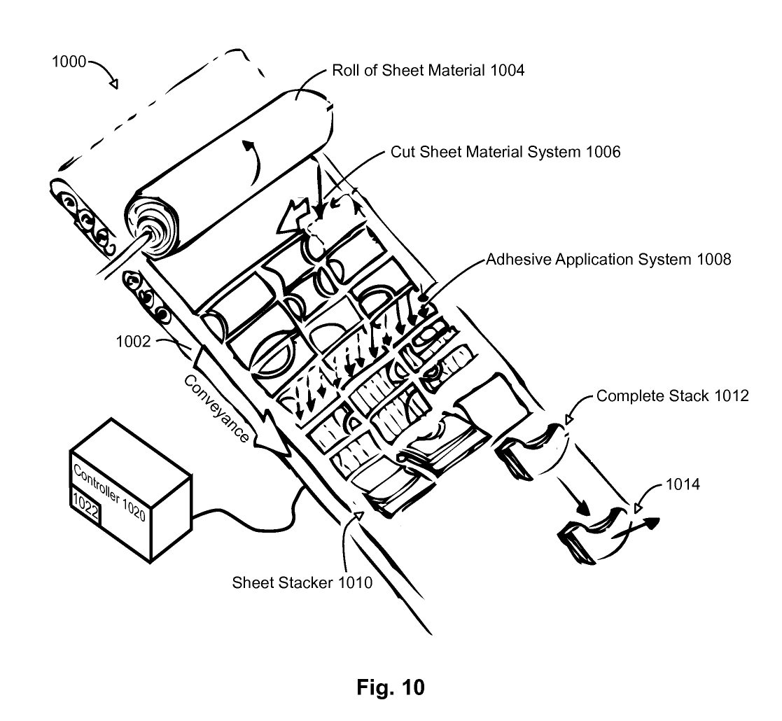

FIG. 10 is a system 1000 for forming honeycomb structures 200, 300, 400, in accordance with one or more embodiments of the present invention. The system 1000 includes a sheet material moving system 1002 capable of moving the sheet material 1004 along a surface. The sheet material moving system 1002 can be, for example, a conveyor belt or an equivalent or other suitable sheet material moving system.

The system 1000 also includes a cutting system 1006. The cutting system 1006 cuts the sheet material 1004 into the sheets 102A-J, 302A-J, 402A-J having selected sizes and shapes.

The system 1000 also includes an adhesive application system 1008. The adhesive application system 1008 applies adhesive to the sheets 102A-J, 302A-J, 402A-J along parallel connection lines 103A-J.

The system 1000 also includes a stacker 1010. The stacker stacks the sheets 102A-J, 302A-J, 402A-J into stacks, each stack having the sheets required to form a desired honeycomb structure.

After a stack 1012 containing all the sheets 102A-J, 302A-J, 402A-J needed to form a honeycomb structure 200, 300, 400 has been formed, the stack is transferred to a shaper 1014. The shaper 1014 spreads the stack 1012 to form a honeycomb structure 200, 300, 400 by a variety of methods.

The system 1000 also includes a controller 1020. The controller 1020 includes operating software 1022 for operating the system 1000. The controller 1020 is coupled to the components 1002, 1006, 1008, 1010 and 1014 so as to control the operation of the components. The operating software 1022 includes the operative instructions for controlling the components 1002, 1006, 1008, 1010 and 1014. The operating software 1022 can include the method and operations 500, 550 described above in machine readable and executable code for automatically cutting the selected sheets 102A-J, 302A-J, 402A-J in the selected shape as needed to form the honeycomb structure 200, 300, 400. The operating software 1022 can also include the software for connecting the sheets 102A-J, 302A-J, 402A-J along the desired connection lines and forming the honeycomb structure 200, 300, 400.

The system 1000 can also include subsystems for forming the expandable outer casing 610 as part of the honeycomb structure 200, 300, 400. The system 1000 can also include subsystems for forming the sleeve 700 described above.

The invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data maybe processed by other computers on the network, e.g., a cloud of computing resources.

The embodiments of the present invention can also be defined as a machine that transforms data from one state to another state. The transformed data can be saved to storage and then manipulated by a processor. The processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

The invention can also be embodied as computer readable code and/or logic on a computer readable medium. The computer readable medium is any data storage device that can store data which can thereafter be read by a computer system. Examples of the computer readable medium include hard drives, network attached storage (NAS), logic circuits, read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of forming a honeycomb structure comprising:
selecting a desired honeycomb structure shape;
forming a plurality of two dimensional sheets into desired two dimensional shapes corresponding to the selected honeycomb structure shape including:
creating a three-dimensional honeycomb model including a first set of coordinates;
selecting a sheet in the three-dimensional honeycomb model;
identifying a second set of coordinates in the selected sheet, the second set of coordinates being a subset of the first set of coordinates;
translating the second set of coordinates to a third set of coordinates, the third set of coordinates being relative to a selected point in the selected sheet;
creating a space model of a three-dimensional space in the honeycomb structure;
identifying portion of the third set of coordinates are included in the space model; and
identifying cutouts in the selected sheet;
stacking the plurality of two dimensional sheets;
connecting the plurality of two dimensionally shaped sheets along corresponding connection lines; and
spreading the plurality of sheets apart.

2. The method of claim 1, wherein selecting the desired honeycomb structure shape includes selecting a honeycomb structure density, including selecting a number of two-dimensional sheets in the plurality of two-dimensional sheets and selecting a spacing interval between the corresponding connection lines on each of the plurality of two-dimensional sheets.

3. The method of claim 1, wherein selecting the desired honeycomb structure shape includes selecting a honeycomb structure orientation.

4. (canceled)

5. The method of claim 1, wherein the three-dimensional space model is a space formed in the honeycomb structure.

6. The method of 1 claim 1, wherein the three-dimensional space model includes at least one of a curve, a complex curve or a straight edge.

7. The method of claim 1, further comprising attaching a stiffening sheet to the honeycomb structure.

8. The method of claim 1, further comprising attaching an expandable outer casing to a top sheet and a bottom sheet of the honeycomb structure.

9. The method of claim 8, wherein the expandable outer casing includes at least one side, the at least one side having a fold.

10. The method of claim 8, wherein spreading the plurality of sheets apart includes moving the fold in the at least one side of the expandable outer casing toward the honeycomb structure.

11. The method of claim 10, further comprising securing the at least one side of the expandable outer casing such that the honeycomb structure is held in an extended orientation.

12. The method of claim 11, wherein securing the at least one side of the expandable outer casing includes placing a sleeve over the honeycomb structure.

13. A system for forming a honeycomb structure comprising:
a forming system for forming a plurality of substantially two dimensional sheets into desired two dimensional shapes corresponding to a selected honeycomb structure shape;
a adhesive application system for connecting the plurality of two dimensionally shaped sheets along corresponding connection lines;
a shaping system for spreading the plurality of sheets apart; and
a controller including:
logic for creating a three-dimensional honeycomb model including a first set of coordinates;
logic for selecting a sheet in the three-dimensional honeycomb model;
logic for identifying a second set of coordinates in the selected sheet, the second set of coordinates being a subset of the first set of coordinates;
logic for translating the second set of coordinates to a third set of coordinates, the third set of coordinates being relative to a selected point in the selected sheet;
logic for creating a space model of a three-dimensional space in the honeycomb structure;
logic for identifying a portion of the third set of coordinates included in the space model; and
logic for identifying a cutouts in the selected sheet.

14. (canceled)

15. (canceled)

16. The system of claim 13, further comprising logic for selecting a desired honeycomb structure shape including logic for selecting a honeycomb structure density, including logic for selecting a number of two-dimensional sheets in the plurality of two-dimensional sheets and logic for selecting a spacing interval between the corresponding connection lines on each of the plurality of two-dimensional sheets.

17. A packing system comprising:
a forming system for forming a plurality of substantially two-dimensional sheets into desired two-dimensional shapes corresponding to a selected honeycomb structure shape corresponding to an object to be supported in the packing system;
a adhesive application system for connecting the plurality of two-dimensionally shaped sheets along corresponding connection lines;
a shaping system for spreading the plurality of sheets apart; and
a controller including:
logic for creating a three-dimensional honeycomb model including a first set of coordinates;
logic for selecting a sheet in the three-dimensional honeycomb model;
logic for identifying a second set of coordinates in the selected sheet, the second set of coordinates being a subset of the first set of coordinates;
logic for translating the second set of coordinates to a third set of coordinates, the third set of coordinates being relative to a selected point in the selected sheet;
logic for creating a space model of a three-dimensional space in the honeycomb structure;
logic for identifying a portion of the third set of coordinates included in the space model; and
logic for identifying a cutouts in the selected sheet.
